(19) United States
(12) Patent Application Publication
(10) Pub. No.: US 2011/0167203 A1
(43) Pub. Date: Jul. 7, 2011

(54) METHOD AND APPARATUS FOR CACHE CONTROL IN A DATA STORAGE DEVICE

(75) Inventors: Kenji YOSHIDA, Akishima-shi (JP); Tomonori MASUO, Iruma-shi (JP); Shuichi ISHII, Ome-shi (JP); Kunio UTSUKI, Tachikawa-shi (JP); Kazuya TAKADA, Kodaira-shi (JP)

(73) Assignee: KABUSHIKI KAISHA TOSHIBA, Tokyo (JP)

(21) Appl. No.: 13/036,662

(22) Filed: Feb. 28, 2011

Related U.S. Application Data
(63) Continuation of application No. 12/784,334, filed on May 20, 2010.

(30) Foreign Application Priority Data
Jul. 17, 2009 (JP) 2009-169257

(51) Int. Cl. G06F 12/08; G06F 12/00

(52) U.S. Cl. 711/103; 711/113; 711/118; 711/E12.019; 711/E12.008

(57) ABSTRACT

According to one embodiment, a data storage device is provided, which has a cache controller that performs cache control, by using a buffer memory divided into segments, which are managed. The cache controller performs sequential hit judge on each segment, in accordance with the requested access range designated by a read or write command coming from a host system. The cache controller updates the hit upper-limit LBA set for each segment if the result of the hit judge is a mishit.

### CROSS-REFERENCE TO RELATED APPLICATIONS

This application is a continuation of U.S. patent application Ser. No. 12/784,334, filed May 20, 2010, which is based upon and claims the benefit of priority from Japanese Patent Application No. 2009-169257, filed Jul. 17, 2009, the entire contents of each of which are incorporated herein by reference.

### BACKGROUND

1. Field

One embodiment of the present invention relates to a data storage device such as a disk drive, and more particularly to a cache control technique.

2. Description of the Related Art

Data storage devices (hereinafter referred to as “disk drives”), such as hard disk drives (HDDs) and solid-state drives (SSDs) transfer read data in response to a read command coming from a host system, or records write data on, for example, a disk (i.e., recording medium) in response to a write command coming from the host system. The host system is an electronic apparatus such as a personal computer or a digital television receiver.

Most disk drives have a buffer memory constituted by a DRAM. The buffer memory is used, performing a cache function. This enhances the response ability that the disk drive has with respect to the host system. The cache function includes a read cache and a write cache.

The read cache holds, in the buffer memory, the read data (including the pre-read data) read from a disk in the past, in response to a read command issued from the host system. Further, the read cache reads the read data hit in the buffer memory, in response to a new read command issued from the host system, and transfers this read data to the host system.

On the other hand, the write cache holds, in the buffer memory, the write data transferred from the host system, in response to a write command issued from the host system in the past. The write data held in the buffer memory is transferred to, and recorded on, the disk as needed. As a cache control method for use in disk drives, a method has been proposed, in which the storage area of the buffer memory is divided into a plurality of segments and the data items stored in the segments are managed (see, for example, Jpn. Pat. Appln. KOKAI Publication No. 2001-134488). In this prior-art method, the read cache performs automatic hit function on the plurality of segments.

The prior-art cache method specified above is a method in which a hardware controller determines whether a hit has been made, while the read command is being processed. More specifically, in a limited state where the complex process of determining read hits need not be performed, the hardware controller checks, under the control of hardware, the continuity of the logic block address (LBA) designated by a command coming from the host system. It is thereby determined whether a hit has been made. The response ability that the disk drive has with respect to the host system is ultimately enhanced.

If the host system issues a new write command, however, the hit judge function of the controller must be switched off (that is, the hit judge function must be nullified) in order to preserve the coherency of the data. In other words, if both a read command and a write command are issued, whether a hit has been made in respect to any following commands may not be continuously determined.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the major components of a disk drive according to an embodiment of this invention;

FIG. 2 is a diagram explaining the configuration of the buffer memory used in the embodiment;

FIG. 3 is a diagram explaining the configuration of segment management data used in the embodiment;

FIGS. 4A and 4B are diagrams explaining the cache used in the embodiment;

FIGS. 5A and 5B are diagrams explaining the process of updating the upper-limit LBA in the embodiment;

FIGS. 6A, 6B, 6C and 6D are diagrams explaining a process of detecting overlaps in the embodiment; and

FIG. 7 is a flowchart explaining the cache control performed in the embodiment.

### DETAILED DESCRIPTION

Various embodiments according to the invention will be described hereinafter with reference to the accompanying drawings.

The embodiment provides a data storage device that performs a cache function of continuously determining hits of a hardware controller.

[Configuration of the Disk Drive]

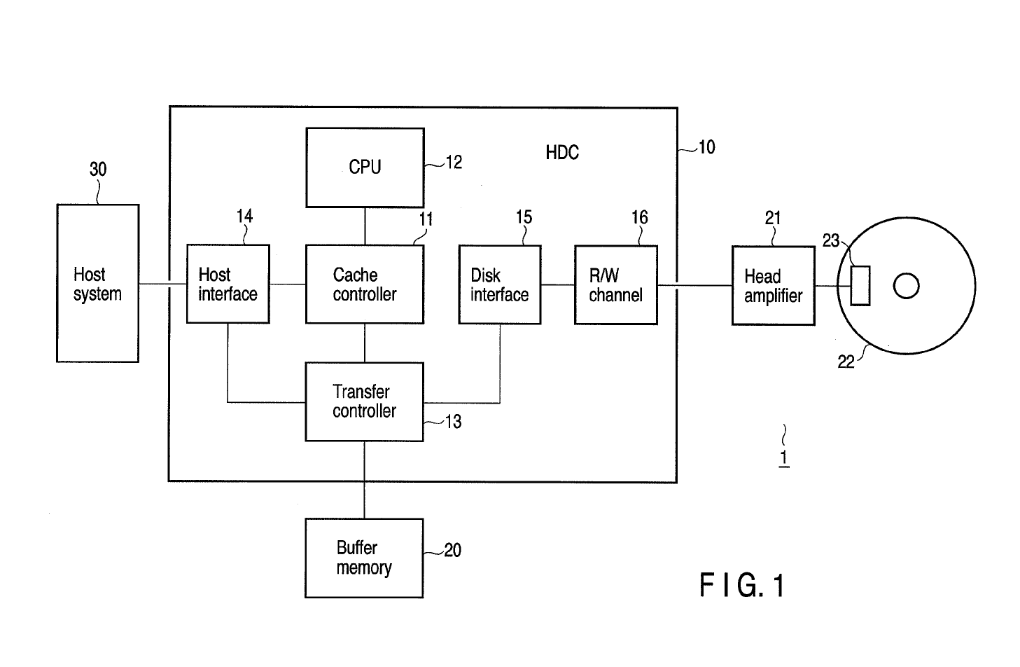

According to the embodiment, FIG. 1 is a block diagram that shows the configuration of a disk drive 1.

The embodiment is applied to the disk drive 1 that is used as a data storage device. As shown in FIG. 1, the disk drive 1 has a hard disk controller (HDC), hereinafter called a “disk controller”) 10, a buffer memory 20, a head amplifier 21, a disk 22 used as recording medium, and a head 23.

The head amplifier 21 receives a read signal read from the disk 22 by the head 23 and amplifies the read signal. The read signal amplified is transmitted to the disk controller 10. The head amplifier 21 receives write data from the disk controller 10 and converts the write data to a write signal. The write signal is transmitted to the head 23.

The disk controller 10 constitutes an interface that transfers data between the disk 22 and a host system 30. The host system 30 is an electronic apparatus such as a personal computer or a digital television receiver.

The disk controller 10 is a one-chip integrated circuit having a cache controller 11, a microprocessor (CPU) 12, a transfer controller 13, a host interface 14, a disk interface 15, and a read/write (R/W) channel 16.

The cache controller 11 performs cache control, which will be explained later. The CPU 12 processes firmware, performing the cache control and the read/write control. The transfer controller 13 controls the data transfer between the disk 22 and the host system 30.

The host interface 14 is an interface that transfers data between the disk drive 1 and the host system 30 and receives a read command or a write command issued from the host system 30. Further, the host interface 14 receives the write data transferred from the host system 30 and transfers the write data via the transfer controller 13 to the buffer memory 20. The host interface 14 receives the read data read from the buffer memory 20 by the transfer controller 13 and transfers the read data to the host system 30.

The disk interface 15 is an interface that transfers data between the buffer memory 20 and the disk 22. The disk interface 15 receives the write data read from the buffer memory 20 by the transfer controller 13 and transfers the write data to the R/W channel 16. Moreover, the disk interface 15 receives the read data output from the R/W channel 16 and transfers the read data via the transfer controller 13 to the buffer memory 20.

The R/W channel 16 is a read/write-signal processing circuit, which encodes the write data transmitted from the host system 30 and decodes the read signal transmitted from the head amplifier 21.

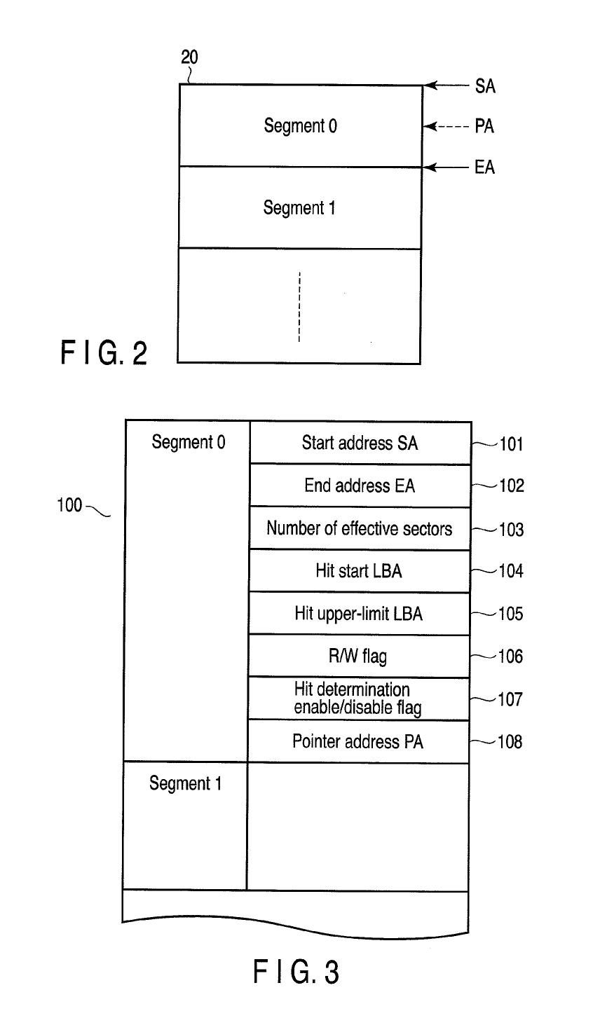

The buffer memory 20 is constituted by a dynamic random access memory (DRAM). As shown in FIG. 2, the buffer memory 20 has a data storage area, which is divided into a plurality of segments (0, 1, . . . ). Each segment is not fixed in position in the data area, but at random in the data area. Each segment is set as read-cache segment or write-cache segment.

As shown in FIG. 3, the cache controller 11 holds segment management data (table) 100. In accordance with the segment management data 100, the cache controller 11 performs cache control using the buffer memory 20.

[Cache Control]

First, the ordinary cache control performed in the conventional disk drives will be explained.

In the ordinary cache control, the CPU 12 processes the firmware, whereby a complex hit judge process is performed on each segment of the buffer memory 20. More precisely, the host system 30 may issue several write commands of LBA No. 100. In this case, the latest data items associated with these write commands must be searched for in the buffer memory 20. This complex hit judge process preserves the coherency of cache data.

Note that the logical block address (LBA) is an address designated by a command issued from the host system 30. The logical block address is associated with an address on the disk 22.

In the cache control according to this embodiment, the cache controller 11 (hardware) determines whether a hit has been made, for the purpose of enhancing the response ability with respect to the host system 30. This hit judge function is called “sequential hit judge function.” Assume that data is stored in the write-cache segments for LBAs Nos. 100 to 199, and that the host system 30 issues write commands for LBAs Nos. 200 to 299.

Then, the sequential hit judge function which is a function of causing the hardware cache controller 11 to determine whether a hit has been made by checking the continuity of the end address of the previous write command and the start address of the current write command, determines “hit”, prompting the host system 30 to transfer write data, without using the firmware in the CPU 12. The sequential hit judge function also determines whether a hit has been made in the case where the host system 30 issues a read command, by checking the continuity of the end address of the previous read command and the start address of the current read command.

However, if the result of the sequential hit judge turns out to be a mishit, if a write command is issued while the sequential hit judge is possible for read commands, or if a read command is issued while the sequential hit judge is possible for write commands, the sequential hit judge function must be temporarily nullified in order to preserve the coherency of cache data.

To be more specific, during the process of processing, for example, a read command, both the data at the LBA designated by this command and the data at the next LBA are stored, as pre-read data, in the buffer memory in the process of storing any data items read from the disk are stored in the buffer memory. If a write command for some of LBAs Nos. 200 to 299 is issued, the pre-read data is stored in, for example, the cache area defined by LBAs Nos. 200 to 299. In this case, the sequential hit judge function is temporarily switched off in order to preserve the coherency of cache data. Thereafter, the sequential hit judge function become on after the firmware (CPU 12) checks the cache area provided in the buffer memory and judges that the HW sequential hit function can be enabled.

Thus, this embodiment is configured to accomplish cache control in which the sequential hit judge can be continuously performed on any commands after a read command or a write command has been issued. The cache control this embodiment achieves will be explained in detail, with reference to FIGS. 2 to 7.

The cache controller 11 uses the segment management data 100, as shown in FIG. 3, for every segment. Thus, the cache controller 11 manages the segments, i.e., cache areas secured in the buffer memory 20. Each segment is defined by a start address (SA) 101 and an end address (EA) 102. The segment is thereby secured as a cache area in the buffer memory 20. The start address SA and the end address EA are managed by the CPU 12 that executes the firmware, and are then set as items constituting the segment management data 100. That is, the firmware sets the start address SA and the end address EA in the cache controller 11 that is hardware.

The segment management data 100 contains number of effective sectors of each segment (i.e., the number of read sectors that are read from disk interface 15, but not sent to host through host interface 14, or the number of write sectors that are read from host interface 14, but not sent to disk through disk interface 15) 103, a hit-start LBA 104, a hit upper-limit LBA 105, a R/W flag 106 identifying either read or write, a hit judge enable/disable flag 107, and a pointer address PA 108.

The cache controller (hardware) 11 increases, by one (+1), the number of effective sectors 103 every time the disk drive 1 receives one-sector data from the host system 30 while a write command is being executed. Conversely, the hardware 11 decreases, by one (−1), the number of effective sectors 103 every time the disk drive 1 writes one-sector data on the disk 22. On the other hand, while a read command is being processed, The cache controller (hardware) 11 increases, by one (+1), the number of effective sectors every time the disk controller 10 receives one-sector data from the disk 22, and decreases, by one (−1), the number of effective sectors every time the disk drive 1 transfer one-sector data to the host system 30.

If a host issues a read command that starts from “LBA1” to “LBA2”, and this command caused a sequential hit at one segment°, the cache controller 11 sets updates the hit-start LBA 103 of segment° in the segment management data 100 as, “LBA2”+1. If a host issues a write command that starts from “LBA3” to “LBA4”, and this command caused a sequential hit at segment1, The cache controller 11 updates the Hit start LBA 104 as “LBA4+1”. hit upper-limit LBA 105 is used to limit the upper address of the host transfer in a command to cause a hit. This upper-limit LBA is set to a value that are more than the hit start LBA 104, and the data associated with the LBA is stored in the buffer memory 20.

The R/W flag 106 is a flag that represents whether the segment is used as the write cache or as the read cache. The value of 1 represents the segment is used as the read cache, and the value of 0 represents the segment is used as the write cache. The CPU 12 executes firmware, setting the R/W flag 106. The hit judge enable/disable flag 107 is a flag that indicates whether the cache controller 11 should be enabled or disabled to perform the sequential hit judge for the segment. The CPU 12 executes firmware, setting hit judge enable/disable flag 107.

As shown in FIG. 2, the pointer address PA 108 is maintained by the cache controller 11 and indicates the pointer address that are currently used to store the data from the host/to read the data to the host.

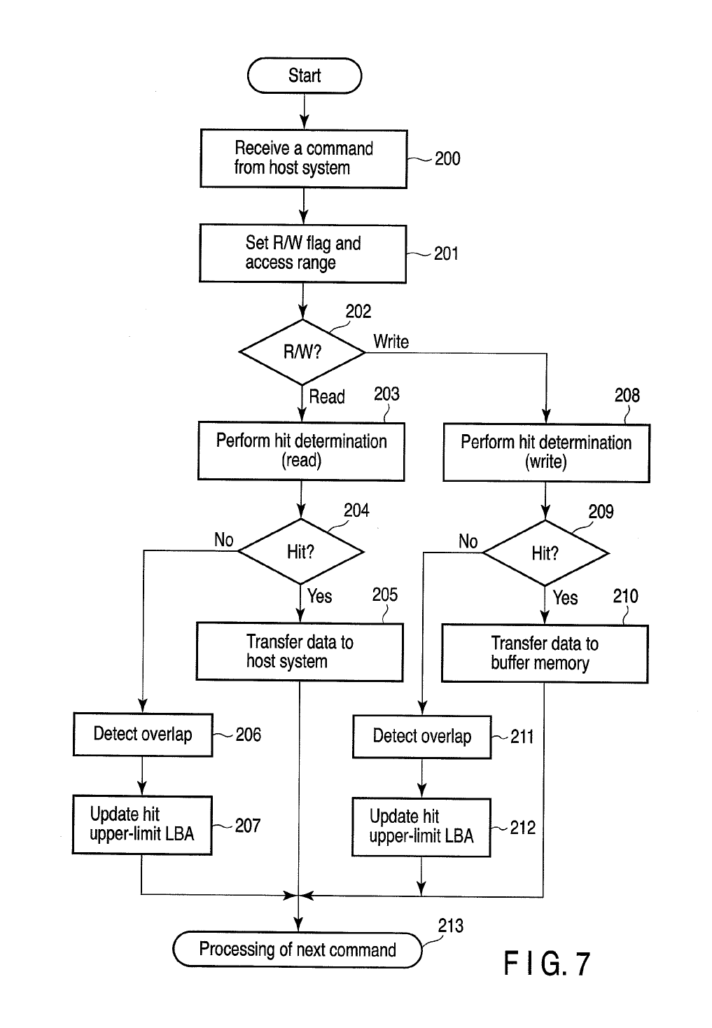

When a write command is issued from the host system 30 (see Block 200 shown in FIG. 7), the cache controller (hardware) 11 starts the sequential hit judge for the write cache. The cache controller 11 recognizes the access range on the basis of the start address (start LBA) and the end address (end LBA), both designated by the command (Block 201). Note that the end address is “the start address+the number of sectors to be transferred−1.”

The cache controller 11 executes a sequential hit judge only for the segments whose R/W flag is 1 in a read command case, and whose R/W flag is 0 in a write command case. (Block 202). More specifically, on receiving a read command from the host system 30, the cache controller 11 performs the sequential hit judge (hereinafter called “hit judge”) for the read cache (Block 203). On receiving a write command from the host system 30, the cache controller 11 performs the hit judge for the write cache (Block 208).

In the sequential hit judge performed on each segment, a “hit” is determined if three conditions are satisfied. First, the read/write attribute set for the segment by the R/W flag 106 is identical to the read/write attribute of the command (read or write command) issued from the host system 30. Second, the hit start LAB 104 set for the segment is identical to the start LBA designated by the command issued from the host system 30. Third, the end LBA designated by the host system 30 is less than the hit upper-limit LBA 105 set for the segment.

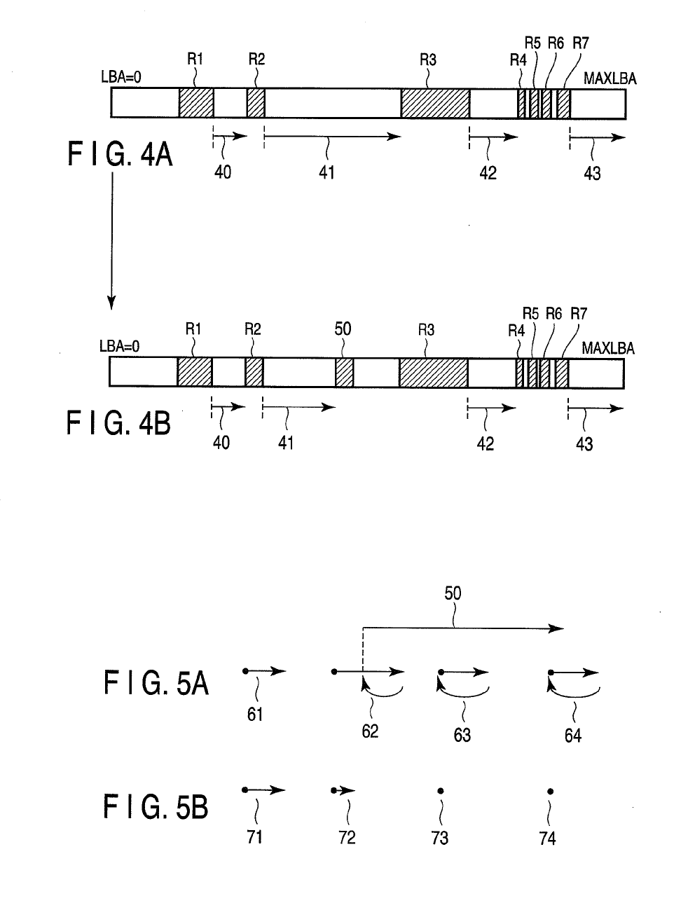

FIGS. 4A and 4B are diagram showing an example of sequential hit range.

As shown in FIG. 4A, assume that the buffer memory stores some data whose address range is shown in R1 through R7. In this case, for each segments, the hit start address and hit upper-limit address pair is illustrated as an arrow of 40, 41, 42 and 43. The cache controller 11 can perform the hit judge against the ranges 40, 41, 42 and 43. The read/write attribute of each segment is determined by the attribute of the data (i.e., data/write data to be cached) range in the segment.

Now assume that a command is issued from the host system 30 and its address ranges as shown in 50. In the case, after the controller 11 perform the hit judge, the hit upper-limit address of the arrow 41 is updated as is illustrated in FIG. 4B. More precisely, the upper limit of the address range 41 is rewritten by the cache controller 11 and the value become same as the start address of the command from host system 30.

The CPU manages all the cached data in the buffer space and configures the cache controller 11 so that it can perform hit judge (i.e., sequential hit judge) only to a segments whose possible hit space is wide enough. Therefore, if the range over which the hit judge can be performed is as relatively narrow as, for example, the address ranges shown between R4 and R5, between R5 and R6, and between R6 and R7, cache controller 12 doesn't perform the hit judge.

The cache controller 11 performs the sequential hit judge for the read cache, in response to a read command. If the cache controller 11 determines a hit (YES in Block 204), the cache controller 11 reads data from the segment that has been hit and transfers the read data to the host system 30 (Block 205). In response to a write command, the cache controller 11 performs the sequential hit judge for the write cache. If the cache controller determines a hit (YES in Block 209), the write data transferred from the host system 30 will be transferred to that segment of the buffer memory 20, which has been hit (Block 210).

That is, if the result of the hit judge performed for the read cache is a hit, the data, stored in the segment having read attribute will be transferred to the host system 30, without performing a process of reading data from the disk 22. If the result of the hit judge performed on the write cache is a hit, the write data transferred from the host system 30 will be stored in the segment of write attribute. The data thus stored in the segment of write attribute is written at the associated address on the disk 22. After this data transfer has been achieved, the hit-start LBA of the segment used to achieve the data transfer is updated by the cache controller 11 to the value of LBA+1 transferred from the host system 30 (or to the host system 30).

If the result of the hit judge performed for the read cache is a mishit (or if no hits have been made, if NO in Block 204), a process of reading, from the disk 22, the data designated by the read command will be performed (Block 213). More precisely, the cache controller 11 first performs an overlap-detecting process (Block 206). In this process, it is determined how much the address range of the read command coming from the host system 30 overlaps the address range of the hit target set for the segment (hereinafter called “hit-target range”), with respect to the segment mishit.

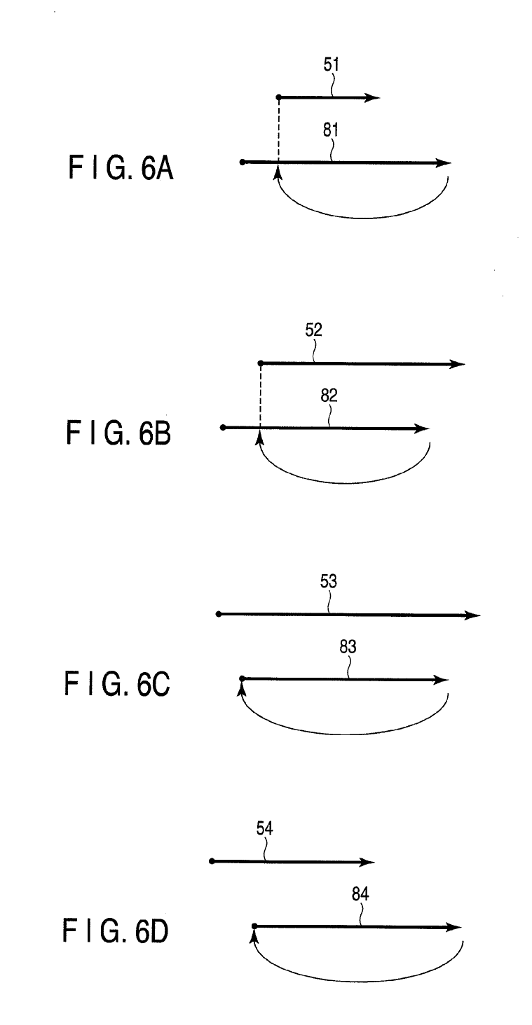

In the overlap-detecting process, one of four overlap states shown in FIG. 6A to 6D, respectively, may be detected. In the overlap state of FIG. 6A, an access range (hereinafter called “requested access range”) 51 designated by the command coming from the host system 30 is inside the range 81 for the segment. In the overlap state of FIG. 6B, the start LBA of a requested access range 52 lies inside a hit-target range 82 and the end LBA of the requested access range 52 exceeds the upper-limit LBA of the hit-target range 82. FIG. 6C shows the overlap state of, the requested access range 53 falls outside the hit-target range 83, at both the start LBA and the end LBA. In the overlap state of FIG. 6D, the start LBA of a requested access range 54 falls outside a hit-target range 84 and the end LBA of the requested access range 54 lies inside the hit-target range 84.

Based on the overlap state thus detected, the cache controller 11 performs a process of updating the hit upper-limit LBA of the segment (Block 207). More specifically, in the overlap state of FIG. 6A, the cache controller 11 sets the hit upper-limit LBA of the segment at an address that corresponds to the start LBA of the requested access range 51. Similarly, in the overlap state of FIG. 6B, the cache controller 11 sets the hit upper-limit LBA of the segment at an address that corresponds to the start LBA of the requested access range 52. Now that the hit upper-limit LBA has been so updated, the range in which the segment can be hit is narrowed before it is determined whether the read cache has been hit in the process of the next read command.

In the overlap state of FIG. 6C, the cache controller 11 sets the hit upper-limit LBA of the segment in alignment with the hit start LBA thereof. Similarly, in the overlap state of FIG. 6D, the cache controller 11 sets the hit upper-limit LBA of the segment in alignment with the hit start LBA thereof. Now that the hit upper-limit LBA has been so updated, the state in which the segment cannot be hit is set before it is determined whether the read cache has been hit in the process of the next read command.

If the result of the hit judge performed for the write cache is a mishit (NO in Block 209), the cache controller 11 goes to a process of writing, on the disk 22, the data falling within the request access range designated by a write command (Block 213). Even in the case of the mishit of the write cache, the cache controller 11 performs an overlap-detecting process similar to the above-described process (Block 211). Further, as in the case described above, the cache controller 11 performs a process of updating the hit upper-limit LBA of the segment, on the basis of the overlap state detected (Block 212).

Note that the hit upper-limit LBA of each segment is set such that the value excess the LBA currently transferred from/to the host system 30, and is the upper limit not overlapping the LBA of any other data cached. The hit upper-limit LBA may be set by FW as the LBA value corresponds to the last LBA of the pre-fetched read data in the segment.

In the cache control method according to this embodiment, the hit upper-limit LBA of each segment is rewritten, as needed, if the hardware 11 determines a mishit, as has been described above. More precisely, the process of detecting an overlap and the process of updating the hit upper-limit LBA of the segment are performed. This can prevent the address space defined by the hit start LBA and hit upper-limit LBA of the segment from overlapping the space of any other cached data, even after the disk drive 1 has received the data associated with a write command issued from the host system 30. Hence, a read command and a write command are issued, if both issued, can be continuously executed, without interrupting the sequential hit judge performed on the next command.

In other words, the cache controller 11 having a plurality of segments can keep performing the sequential hit judge on the next command, even if a write command is issued while the controller 11 remains able to determine whether a read cache or a write cache has been hit. The cache controller 11 can therefore keep performing the hit judge. This serves to enhance the response ability the disk drive 1 has with respect to the host system 30.

The process of updating the hit upper-limit LBA of the segment is performed on all the segments that the cache controller 11 manages. That is, even if the read/write attribute of the command coming from the host system 30 is not identical to the attribute of the segment, the cache controller 11 updates the hit upper-limit LBA. More specifically, the cache controller 11 updates the hit upper-limit LBA for both read-cache and write-cache segments while a read command is being processed. While a write command is being processed, the controller 11 updates the hit upper-limit LBA for both read-cache and write-cache segments. In the hit judge process, however, the command attribute and the segment attribute must be identical, as pointed out above.

FIGS. 5A and 5B are diagrams explaining the process of updating the upper-limit LAB for a plurality of segments.

FIG. 5A illustrates the hit-target ranges 61 to 64 for a plurality of segments. FIG. 5B shows hit-target ranges 71 and 72 and hit disabled states 73 and 74. The hit-target range 72 has been narrowed in the process of updating the hit upper-limit LBA. In the hit disabled states 73 and 74, no hits can be made. Note that the hit-target range 71 does not change at all.

Note that the process of updating the hit upper-limit LBA, performed in this embodiment, is based on the presupposition that the start LBAs of all segments do not overlap the upper-limit LBA. That is, if a command has hit a segment, the upper-limit LBA of any other need not be updated at all.

The hit judge enable/disable flag 107 contained in the segment management data 100 is set to value 0 if the hit judge should not be performed because the firmware (i.e., CPU 12) has but a small area for the segment. That is, the flag 107 is a flag that disables the hit judge function and the function of detecting an overlap at the time a mishit.

In the overlap state of FIG. 6C, the overlap state of FIG. 6B or the overlap state of FIG. 6C, the cache controller 11 may set the hit judge enable/disable flag 107 to “0” (i.e., No) to render the hit judge impossible, instead of performing the process of updating the hit upper-limit LBA.

The embodiment described above is applied to the disk drive 1 used as data storage device. Nonetheless, the embodiment can be used in solid-state drives (SSDs) that are memory modules, each incorporating a flash memory as recording medium.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data storage device comprising:
a controller configured to perform cache control with a buffer memory divided into segments, the controller comprising:
a hit determination module configured to determine a sequential hit for each of the segments, in accordance with a requested access range designated by a read or write command from a host system, a hit address range of the sequential hit being defined by a hit start address and a hit upper-limit address set for each of the segments, the hit start address being a next address of an end address used in data transfer for the read or write command; and
an update module configured to update the hit upper-limit address if the result of the sequential hit determination is a miss, on the basis of an overlap state of the requested access range and the hit address range.

2. The data storage device of claim 1, wherein the hit determination module is configured to output a result of sequential hit determination, indicating a hit, if a start address of the requested access range is identical to the hit start address and if an end address of the requested access range is smaller than the hit upper-limit address.

3. The data storage device of claim 2, wherein the update module is configured to update the hit upper-limit address with an address corresponding to the start address of the requested access range, if the overlap state is a state in which the requested access range corresponds to part of the hit address range.

4. The data storage device of claim 2, wherein the update module is configured to update the hit upper-limit address with an address corresponding to the start address of the requested access range, if the overlap state is a state in which the start address of the requested access range is within the hit address range, and the end address of the requested access range is greater than the hit upper-limit address.

5. The data storage device of claim 2, wherein the update module is configured to update the hit upper-limit address with an address corresponding to a start address, if the overlap state is a state in which the requested access range is beyond the hit address range.

6. The data storage device of claim 2, wherein the update module is configured to update the hit upper-limit address to correspond to a start address, if the overlap state is a state in which the start address of the requested access range is out of the hit address range, and the end address is within the hit address range.

7. The data storage device of claim 1, wherein the controller is configured to store management data for determining a hit for each of the segments, the management data comprises an address range of the buffer memory, the hit start address, the hit upper-limit address, and information representing a read or write attribute.

8. The data storage device of claim 5, wherein the management data comprises a flag representing whether it is possible to determine a hit for a particular segment; and
the update module is configured to update the flag to indicate that the sequential hit determination is disabled, if the overlap state is a state in which a start address of the requested access range is smaller than the hit start address and an end address of the requested access range is equal to or greater than the hit upper-limit address.

9. The data storage device of claim 7, wherein the management data comprises a flag representing whether hit determination for each of the segments is enabled or not, and
the update module is configured to update the flag to indicate that the sequential hit determination is disabled, if the overlap state is a state in which a start address of the requested access range is out of the hit address range, and the end address is within the hit address range.

10. A disk drive comprising:
a disk from which read data is read or on which write data is recorded; and
a data storage device comprising:
a controller configured to perform cache control with a buffer memory divided into segments, the controller comprising:
a hit determination module configured to determine a sequential hit for each of the segments, in accordance with a requested access range designated by a read or write command from a host system, a hit address range of the sequential hit being defined by a hit start address and a hit upper-limit address set for each of the segments, the hit start address being a next address of an end address used in data transfer for the read or write command; and
an update module configured to update the hit upper-limit address if the result of the sequential hit determination is a miss, on the basis of an overlap state of the requested access range and the hit address range,
wherein the read data is transferred from the disk to the buffer memory, and the write data is transferred from the buffer memory to the disk.

11. A storage drive comprising:
a flash memory from which read data is read or on which write data is recorded; and
a data storage device comprising:
a controller configured to perform cache control with a buffer memory divided into segments, the controller comprising:
a hit determination module configured to determine a sequential hit for each of the segments, in accordance with a requested access range designated by a read or write command from a host system, a hit address range of the sequential hit being defined by a hit start address and a hit upper-limit address set for each of the segments, the hit start address being a next address of an end address used in data transfer for the read or write command; and
an update module configured to update the hit upper-limit address if the result of the sequential hit determination is a miss, on the basis of an overlap state of the requested access range and the hit address range, wherein the read data is transferred from the flash memory to the buffer memory, and the write data is transferred from a buffer memory to the flash memory.

12. An electric device comprising:
a data storage device comprising:
a controller configured to perform cache control with a buffer memory divided into segments, the controller comprising:
a hit determination module configured to determine a sequential hit for each of the segments, in accordance with a requested access range designated by a read or write command from a host system, a hit address range of the sequential hit being defined by a hit start address and a hit upper-limit address set for each of the segments, the hit start address being a next address of an end address used in data transfer for the read or write command; and
an update module configured to update the hit upper-limit address if the result of the sequential hit determination is a miss, on the basis of an overlap state of the requested access range and the hit address range, and
a module configured to process data by using data stored in the buffer memory.

13. A method of cache control with a buffer divided into segments the method comprising:
determining a sequential hit for each of the segments, in accordance with a requested access range designated by a read or write command from a host system, a hit address range of the sequential hit being defined by a hit start address and a hit upper-limit address set for each of the segments, the hit start address being a next address of an end address used in data transfer for the read or write command;
detecting an overlap state of the requested access range and the hit address range, if the result of the sequential hit determination is a miss; and
updating the hit upper-limit address based on the overlap state.
